(19) United States
(12) Patent Application Publication
(10) Pub. No.: US 2010/0216962 A1
(43) Pub. Date: Aug. 26, 2010

(54) METHOD FOR NEUTRALIZING A WATER-SOLUBLE ACRYLIC POLYMER BY AT LEAST ONE MONOVALENT AGENT AND AT LEAST ONE DIVALENT AGENT, AND POLYMERS OBTAINED

(75) Inventors: Olivier GUERRET, La Tour De Salvagny (FR); Jean-Marc SUAU, Lucenay (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: COATEX S.A.S, Genay (FR)

(21) Appl. No.: 12/706,024

(22) Filed: Feb. 16, 2010

Related U.S. Application Data
(60) Provisional application No. 61/157,268, filed on Mar. 4, 2009.

(30) Foreign Application Priority Data
Feb. 25, 2009 (FR) 09 51192

(51) Int. Cl. C08F 120/06

(52) U.S. Cl. 526/317.1

(57) ABSTRACT

A method for manufacturing a water-soluble acrylic polymer, fully or partially neutralized by at least one monovalent agent and at least one divalent agent, by contacting the monovalent agent, the divalent agent, and a water-soluble acrylic polymer in acid form in an aqueous solution. Polymer obtained. The polymer obtained is limpid, and advantageously has a polymolecularity index between 1.5 and 3.0 for a molecular weight between 5,000 g/mol and 15,000 g/mol.

### REFERENCE TO PRIOR APPLICATIONS

This application claims priority to U.S. provisional application Ser. No. 61/157,268, filed Mar. 4, 2009; and to French patent application 09 51192, filed on Feb. 25, 2009, both incorporated herein by reference.

### FIELD OF THE INVENTION

The present invention pertains to a method for neutralizing a water-soluble acrylic polymer, by at least one monovalent agent and at least one divalent agent, said agents having previously been mixed in an aqueous solution. This technique leads to a limpid polymer with a low polymolecularity index, unlike the prior art which does not make these two properties simultaneously attainable.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

The mineral industry is a major consumer of chemicals. These chemicals are used during the various conversion/modification/treatment steps that the mineral materials undergo. Thus, for a natural or synthetic calcium carbonate, numerous so-called “grinding” operations (reducing the grain size of the particles) in a dry or wet medium, or so-called “dispersion” operations (suspending particles in a liquid), are performed.

These two actions are made easier by the respective implementation of grinding agents, whose role is to facilitate the mechanical action of particle attrition and fragmentation, and dispersing agents, whose function consists of keeping the viscosity of the suspension within acceptable ranges as the mineral materials are added to it.

The prior art is particularly detailed when it comes to such additives. For many years, it has been known that the homopolymers of acrylic acid constitute effective agents for assisting with the dispersion or grinding of the calcium carbonate in a wet medium. By way of reference, one may refer to documents FR 2 539 137, FR 2 683 536, FR 2 683 537, FR 2 683 538, FR 2 683 539 and FR 2 802 830.

For the same type of applications, it is also beneficial to copolymerize acrylic acid with another carboxylic monomer, like methacrylic acid or maleic anhydride, and/or with another ethylenically unsaturated monomer that does not have a carboxylic function, like an acrylic ester: these variants are also described in the previous documents. One may also polymerize acrylic acid with a cationic monomer as indicated in document FR 2 900 411.

Likewise, it is also known how to copolymerize acrylic acid with a non-ionic monomer whose general formula is R—X—R′: R designates a polymerizable bond, X is an oxyalkylated group, and R′ is an aryl and/or alkyl terminal group which is hydrophobic to some extent. Beyond their ability to effectively disperse and grind a calcium carbonate, these polymers contribute additional properties to the end product in which said carbonate is implemented: these properties are particularly affected by the nature of group R′. On this subject, one may refer to documents FR 2 810 261, FR 2 846 978, FR 2 846 972, FR 2 893 031, FR 2 913 426, and FR 2 913 420.

It is known that the polymolecularity index of water-soluble polymers is also a parameter that makes it possible to optimize some of their performances, particularly in terms of dispersing mineral materials. This is reported in the documents “Synthesis and Characterization of Poly(acrylic acid) Produced by RAFT Polymerization. Application as a Very Efficient Dispersant of CaCO3, Kaolin, and TiO2” (Macromolecules, 36(9), 3066-3077, 2003) and “Dispersion of calcite by poly(sodium acrylate) prepared by reversible addition-fragmentation chain transfer (RAFT) polymerization” (Polymer (2005), 46(19), 8565-8572). This polymolecularity index is particularly obtained using so-called “living” polymerization techniques, as illustrated in documents WO 02/070571 and WO 2005/095466.

It is also known that the choice of the specific acrylic polymer's molecular weight may, in certain particular methods for manufacturing calcium carbonate in a wet medium, improve the efficiency of said method: patent EP 1 248 821, for example, highlights carboxylic polymers with a high molecular weight, in order to disperse a significant quantity of a calcium carbonate derived from a step of low-concentration grinding in the absence of polymers. Patent FR 2 514 746, meanwhile, describes a so-called “fragmenting” method making it possible to select polymer chains with a given length, depending on the selected application for the agent in question.

Independent of these various options for improving the practical properties of a dispersing or grinding agent based on an acrylic acid (choosing a comonomer, a polymerization technique, controlling the molecular weight), this is a characteristic to which the person skilled in the art is particularly sensitive: the nature of the neutralization of said polymer. This sensitivity is visible particularly owing to the fact that the neutralization is always claimed as such in all of the patents cited above.

In a very specific manner, it has been shown that the particular choice of certain neutralization agents has led to considerably improved practical properties. In this manner, document EP 0 100 948 shows the benefit of neutralization by implementing a combination of sodium and calcium ions. A generation of later patents (FR 2 683 538 and FR 2 683 539), meanwhile, highlights the pairing of magnesium/sodium ions. Finally, a most recent generation of patents (EP 1 347 834 and EP 1 347 835) which relies on partial neutralization (not all of the carboxylic sites are neutralized) based on the joint action of a monovalent agent (preferentially sodium) and at least one divalent agent (preferentially calcium or magnesium) is known.

It therefore appears that for acrylic polymers used for dispersing or grinding mineral materials, particular neutralization based on a pair made up of at least one monovalent agent and at least one divalent agent represents a major practical benefit. The inventors do not intend to explain how this type of neutralization influences the end properties of the polymer in question, which falls to a specialist of the application. In the present situation, they are concerned strictly with the method for synthesizing these polymers: here, the person skilled in the art is a chemical engineer who specializes in synthesizing water-soluble acrylic polymers. However, neutralizing this type of polymer using a pair made up of at least one monovalent agent and at least one divalent agent currently poses a certain number of problems.

This is because the neutralization method chosen by the person skilled in the art is currently recounted as the state of the art in document WO 91/12278, for a mixture between a monovalent ion and a divalent ion. The document just mentioned is particularly interesting, as it appears to be the only one to fall within the practices of the person skilled in the art in the field of methods for neutralizing a water-soluble acrylic polymer for the aforementioned mixture.

This document recounts the low solubility of calcium and magnesium ions, relative to that of sodium. This naturally encourages the person skilled in the art to carry out neutralization in a sequence: first from an aqueous solution of calcium or magnesium hydroxide, which is left to react, then with a solution of sodium hydroxide. This neutralization method is called a “post-polymerization sequence”. This procedure is very clearly described in comparative examples #2 to #6 of this document. The corresponding tests, however, demonstrated that the obtained polymers are turbid, such turbidity being due to a phenomenon of precipitation (first paragraph, page 3).

In the course of the usual practices of the person skilled in the art (the post-polymerization sequence recounted above), turbidity observed in the end polymer does not come without numerous problems. In a chemical industry whose regulatory restrictions are continuously increasing, in which the end client seeks out the least toxic and hazardous possible solutions, the turbidity of a product constitutes a downside from a marketing standpoint, in contrast to a clear, limpid product. More scientifically speaking, this turbidity is symptomatic of a product that is not homogenous in its solution, because it is tied to the presence of polymers in precipitated form: it is obvious that the end properties of said product may be affected by this. Additionally, these impurities in precipitated form may cause sedimentation problems during storage.

The solution to the problem of turbidity, as recommended by document WO 91/12278, consists of pre-neutralizing the monomer to be polymerized with the divalent agent, polymerizing it, and finishing neutralization with the monovalent agent; this is termed a “pre-neutralization” method. The authors of this document demonstrate that the manufactured polymers are much more limpid than those obtained in the post-polymerization sequence method, with their molecular weight being maintained.

On the other hand, what document WO 91/12278 does not disclose is that the polymerization kinetics of the polymer are deeply affected in the situation of a pre-neutralization method. The tests performed in this application actually demonstrate that the polymolecularity indices are in such cases always greater than 3.0 for a molecular weight between 5,000 g/mol and 15,000 g/mol. However, as explained above, the dispersing and grinding effectiveness of an acrylic polymer is improved if its polymolecularity index is low. The solution proposed by document WO 91/12278 is therefore not satisfactory.

Without wishing to be bound by any theory whatsoever, the inventors believe that the reactional mechanisms of polymerization are deeply affected in the method which is the object of document WO 91/12278, by partial pre-neutralization of the monomer with the divalent agent. This is because polymerization, in this case, deals with two very distinct chemical populations: not-yet neutralized monomers, and monomers neutralized with the divalent agent. It is not surprising that the polymolecularity (or distribution of lengths of polymer chains) ends up being deeply affected thereby.

### DETAILED DESCRIPTION OF THE PREFERRED EMBODIMENTS

Thus, the inventors have developed a method for manufacturing a water-soluble acrylic polymer, fully or partially neutralized by at least one monovalent agent and at least one divalent agent, wherein the neutralization of said polymer is performed via:
1) manufacturing or providing an aqueous solution of said monovalent agent and said divalent agent,
2) mixing said solution with the aqueous solution containing the polymer in acid form.

This method can also be variously described as follows:
mixing an aqueous solution of said monovalent agent and said divalent agent with an aqueous solution containing the polymer in acid form; or
contacting said monovalent agent, said divalent agent and said polymer in acid form in an aqueous solution.
   as it does not require multiple distinct “steps,” or that the person performing the method as first described above separately manufacture or provide an aqueous solution of said monovalent agent and said divalent agent.

Surprisingly, as it had not been disclosed or suggested in the state of the art, the inventive method makes it possible to manufacture water-soluble acrylic polymers neutralized with at least one monovalent agent and at least one divalent agent, which prove to be perfectly limpid. Their turbidity, as measured using the method described in document WO 91/12278, is preferably less than that obtained for polymers resulting from the post-neutralization sequence method, with the advantages thereby contributed: the absence of sedimentation, and the purity and homogeneity of the product. It has even been demonstrated that the inventive method is much faster—and therefore more economical—than the post-neutralization sequence method.

Surprisingly and advantageously, the inventive method appears to be at least as fast as the pre-neutralization method in document WO 91/12278. It leads to polymers that are at least as limpid, but most importantly with polymolecularity indices that are less than 3.0 for a molecular weight between 5,000 g/mol and 15,000 g/mol: as explained above, this constitutes a fundamental technical advantage regarding the practical properties of said polymer.

Thus, a first preferred object of the invention is a method for manufacturing a water-soluble acrylic polymer, fully or partially neutralized by at least one monovalent agent and at least one divalent agent. The neutralization of said polymer can be performed in any of several ways, as discussed above, including:
mixing an aqueous solution of said monovalent agent and said divalent agent with an aqueous solution containing the polymer in acid form;
contacting said monovalent agent, said divalent agent and said polymer in acid form in an aqueous solution.

The aqueous solution containing the monovalent agent and the divalent agent can be prepared for example by mixing given quantities of said agents with water, said agents most commonly being added in the form of an aqueous solution containing said agent; when said agent is a cation (like sodium, magnesium, calcium, etc.) it is preferably added in the form of an aqueous suspension containing the oxide or hydroxide of the corresponding cation. Preferably a stable, homogeneous aqueous solution is provided.

In the present invention the order in which the various components are added and mixed is not important, and can be chosen by the person skilled in the art.

Contacting the monovalent agent, the divalent agent and the polymer in acid form can for example be carried out by continuously and/or gradually and/or in multiple installments by, for example, adding an aqueous solution of the monovalent agent and the divalent agent into an aqueous solution containing the polymer in acid form. One may proceed in reverse, by adding an acidic polymer solution into an aqueous solution of the monovalent agent and the divalent agent. Of course, the method of the invention can also be accomplished in any other way that provides contact, in aqueous solution, between the monovalent agent, the divalent agent, and the polymer in acid form and which results in the manufacture of a water-soluble acrylic polymer, fully or partially neutralized by at least one monovalent agent and at least one divalent agent. In all instances more than one monovalent agent, divalent agent, and polymer in acid form may be present.

Further preferred aspects of the invention method include the production of a polymer that exhibits:
an FTU (formazine turbidity unit) less than 10, for a concentration of 25% of polymer by dry weight,
and a polymolecularity index between 1.5 and 3.0 for a molecular weight between 5,000 g/mol and 15,000 g/mol, preferentially between 8,000 g/mol and 15,000 g/mol.

The FTU turbidity value is a known characteristic, as is the method by which is determined. With regard to the measurement of molecular weight and the polymolecularity index, they are determined using GPC (gelled permeation chromatography) in accordance with the well-known method already described in numerous documents, such as patent EP 1 347 834.

The polymer obtained is preferably limpid, and advantageously has a polymolecularity index between 1.5 and 3.0 for a molecular weight between 5,000 g/mol and 15,000 g/mol.

The monovalent agent is preferably chosen from among primary amines, lithium, potassium, and sodium hydroxides and mixtures thereof. Sodium hydroxide is preferred.

The divalent agent is preferably chosen from among secondary amines, calcium and magnesium hydroxide and/or oxides and mixtures thereof. Calcium and magnesium hydroxide and/or oxides and mixtures thereof are preferred.

In a first variant, the water-soluble acrylic polymer is fully neutralized. In a second variant, the water-soluble acrylic polymer is partially neutralized.

The water-soluble acrylic polymer can be obtained for example by methods of radical polymerization in solution, in a direct or inverse emulsion, in a suspension or precipitation in appropriate solvents, in the presence of catalytic systems and transfer agents, or by processes of controlled radical polymerization, and preferentially by nitroxide-mediated or cobaloxime-mediated polymerization (NMP), by atom transfer radical polymerization (ATRP), or by sulphurated derivative-mediated radical polymerization, said derivatives by chosen from among carbamates, dithioesters or trithiocarbonates (RAFT) or xanthates.

The water-soluble acrylic polymer may, before or after it is neutralized, be treated and separated into several phases, using static or dynamic methods, by one or more polar solvents preferentially belonging to the group constituted by water, methanol, ethanol, propanol, isopropanol, butanols, acetone, tetrahydrofuran or mixtures thereof.

The water-soluble acrylic polymer can be dried.

The water-soluble acrylic polymer can be a homopolymer of acrylic acid, or a copolymer of acrylic acid with another comonomer. Suitable comonomers include monomers with a monocarboxylic function, and preferentially methacrylic, crotonic, isocrotonic, and cinnamic acids, or diacide hemiesters, and preferentially from among monoesters C₁ to C₄ of maleic or itaconic acids, or ethylenically-unsaturated monomers with a dicarboxylic function in an acidic or neutralized state, and preferentially itaconic, maleic, fumaric, mesaconic, or citraconc acid, or is chosen from among carboxylic acid anhydrides.

These comonomers may also include ethylenically-unsaturated monomers which do not have a carboxylic function, such as ethylenically-unsaturated monomers with a sulfonic function in an acidic or neutralized state, and preferentially acrylamido-2-methyl-2-propane-sulfonic acid, sodium methallylsulfonate, sulfonic vinyl acid, and sulfonic styrene acid, or ethylenically-unsaturated monomers with a phosphoric function in an acidic or neutralized state, and preferentially phosphoric vinyl acid, glycol ethylene methacrylate phosphate, glycol propylene methacrylate phosphate, glycol ethylene acrylate phosphate, glycol propylene acrylate phosphate, and their ethoxylates, or ethylenically-unsaturated monomers with a phosphonic function in an acidic or neutralized state, and preferentially phosphonic vinyl acid.

These comonomers may also include cationic monomers like quarternary ammoniums, and preferentially [2-(methacryloyloxy)ethyl]trimethyl ammonium chloride or sulfate, [2-(acryloyloxy)ethyl]trimethyl ammonium chloride or sulfate, [3-(acrylamido) propyl]trimethyl ammonium chloride or sulfate, dimethyl diallyl ammonium chloride or sulfate, and [3-(methacrylamido) propyl]trimethyl ammonium chloride or sulfate.

Lastly, these comonomers may include monomers such as N-[3-(dimethylamino) propyl]acrylamide, N-[3-(dimethylamino) propyl]methacrylamide, unsaturated esters such as N-[2-(dimethylamino) ethyl]methacrylate, or N-[2-(dimethylamino) ethyl]acrylate, or acrylamide, methacrylamide, alkyl acrylates or methacrylates, vinylics, and preferentially vinyl acetate, vinylpyrrolidone, styrene, alphamethylstyrene and derivatives thereof, or monomers whose formula (I) is:

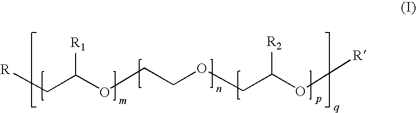

where:
m, n, p and q are whole numbers and m, n, p are less than 150, q is greater than 0, and at least one whole numbers among m, n and p is non zero;
R is a radical that includes a polymerizable unsaturated function;
R₁ and R₂ are identical or different, and represent hydrogen atoms or alkyl groups,
R′ represents hydrogen or an alkyl and/or aryl chain, whether linear or branched, having 1 to 40 carbon atoms.

A second object of the invention relates to a water-soluble acrylic polymer, fully or partially neutralized by at least one monovalent agent and at least one divalent agent, wherein said polymer exhibits:
an FTU (formazine turbidity unit) less than 10, for a concentration of 25% of polymer by dry weight,
and a polymolecularity index between 1.5 and 3.0 for a molecular weight between 5,000 g/mol and 15,000 g/mol, preferentially between 8,000 g/mol and 15,000 g/mol.

All of the above examples and preferences for the invention method apply, as appropriate, to the invention polymer. For example, the monovalent agent is preferably chosen from among primary amines, lithium, potassium, and sodium hydroxides and mixtures thereof, and is preferentially sodium hydroxide. The divalent agent is preferably chosen from among secondary amines, calcium and magnesium hydroxide and/or oxides and mixtures thereof, and preferentially from among calcium and magnesium hydroxide and/or oxides and mixtures thereof. In a first variant, the inventive polymer is fully neutralized. In a second variant, the inventive polymer is partially neutralized. The inventive polymer may be obtained by methods of radical polymerization in solution, in a direct or inverse emulsion, in a suspension or precipitation in appropriate solvents, in the presence of catalytic systems and transfer agents, or by processes of controlled radical polymerization, and preferentially by nitroxide-mediated or cobaloxime-mediated polymerization (NMP), by atom transfer radical polymerization (ATRP), or by sulphurated derivative-mediated radical polymerization, said derivatives by chosen from among carbamates, dithioesters or trithiocarbonates (RAFT) or xanthates. The inventive polymer, before or after it is neutralized, can be treated and separated into several phases, using static or dynamic methods, by one or more polar solvents preferentially belonging to the group constituted by water, methanol, ethanol, propanol, isopropanol, butanols, acetone, tetrahydrofuran or mixtures thereof. The inventive polymer can be dried. The inventive polymer can be a homopolymer of acrylic acid, or a copolymer of acrylic acid with another comonomer. In such a case, the comonomer preferentially belongs to the list of comonomers already indicated above. The polymer is preferably limpid, and advantageously has a polymolecularity index between 1.5 and 3.0 for a molecular weight between 5,000 g/mol and 15,000 g/mol.

The following examples will make it possible to better understand the invention, though without limiting its scope.

### EXAMPLES

In all the tests, the molecular weight and polymolecularity index values are measured in accordance with the method disclosed in document EP 1 347 834.

FTU turbidity (formazine turbidity units) is measured in accordance with the method indicated in document WO 91/12278.

The polyacrylic acids are synthesized in accordance with methods well-known to the person skilled in the art (see all of the documents cited in this application), by techniques whereby the person skilled in the art may, in particular, manufacture a polymer with a given molecular weight.

### Example 1

This example illustrates the manufacture of homopolymers of acrylic acid with a molecular weight in the vicinity of 5,000 g/mol, of which 30% of the carboxylic sites by molar weight are neutralized by the calcium ion and 70% by the sodium ion:
for a post-polymerization sequence method (prior art corresponding to the common practice of the person skilled in the art): test #1,
for the pre-neutralization method (prior art corresponding to the method according to document WO 91/12278): test #2,
for the inventive method: test #3.

### Test No. 1

This test illustrating the prior art is similar to comparative test 1 of document WO 91/12278.

It is begun by adding 250 grams of acrylic acid to 700 grams of water. This acrylic acid is polymerized at about 90° C.

Next, 38 grams of calcium hydroxide are added, and it is left to react for 2 hours, enough time for said hydroxide to dissolve. Next, 225 grams of sodium hydroxide are added at 45% concentration, and it is left to react for 20 minutes.

At the end of the reaction, enough water is added so as to achieve an end concentration of polymer equal to 25% by dry weight.

### Test No. 2

This test illustrating the prior art is similar to comparative test 1 of document WO 91/12278.

In a beaker containing 700 grams of water, 250 grams of acrylic acid and 38 grams of calcium hydroxide are added; the temperature is then about 35° C. and it is left to react for 15 minutes.

Next, the partially neutralized acrylic acid is polymerized.

At the end of the reaction, 225 grams of sodium hydroxide are added at 45% concentration, and it is left to react for 20 minutes.

Finally, enough water is added so as to achieve an end concentration of polymer equal to 25% by dry weight.

### Test No. 3

This test illustrates the invention.

It is begun by polymerizing 250 grams of acrylic acid in 700 grams of water. In 80 grams of water being briskly agitated, 38 grams of calcium hydroxide are added, followed by 225 grams of sodium hydroxide at 45% concentration.

At 80° C., this mixture is added into the aqueous solution of polymerized acrylic acid, and it is left to react for 30 minutes.

Finally, enough water is added so as to achieve an end concentration of polymer equal to 25% by dry weight.

For each of the tests, table 1 shows the total time needed to neutralize the polymer, the FTU turbidity (measured for a concentration of polymer equal to 25% by dry weight), the molecular weight, and the polymolecularity index.

TABLE 1

| | Prior Art | Neutralization | | | |
|---|---|---|---|---|---|
| Test no. | Invention | time | FTU | Mw (g/mol) | Ip |
| 1 | PA | 2 hrs 20 min. | 20 | 5,900 | 2.5 |
| 2 | PA | 35 min. | 11 | 5,600 | 3.1 |
| 3 | Invention | 30 min. | 8 | 6,000 | 2.5 |

These results demonstrate that the inventive polymer is always the most limpid one. Furthermore, the efficiency of the method, in comparison to the post-neutralization sequence method (test #1) has been considerably improved: the neutralization time is much less.

In comparison to the pre-neutralization method (test #2), the resulting polymer has a much lower polymolecularity index: This is a sure sign of better practical performance.

### Example 2

This example illustrates the manufacture of homopolymers of acrylic acid with a molecular weight in the vicinity of 10,000 g/mol, of which 30% of the carboxylic sites by molar weight are neutralized by the calcium ion and 70% by the sodium ion:
for a post-polymerization sequence method (prior art corresponding to the common practice of the person skilled in the art): test #4,
for the pre-neutralization method (prior art corresponding to the method according to document WO 91/12278): test #5,
for the inventive method: test #6.

### Test No. 4

This test illustrates the prior art.

It is begun by adding 250 grams of acrylic acid to 700 grams of water. This acrylic acid is polymerized at about 90° C.

Next, 38 grams of calcium hydroxide are added, and it is left to react for 2 hours, enough time for said hydroxide to dissolve. Next, 225 grams of sodium hydroxide are added at 45% concentration, and it is left to react for 25 minutes.

At the end of the reaction, enough water is added so as to achieve an end concentration of polymer equal to 25% by dry weight.

### Test No. 5

This test illustrates the prior art.

In a beaker containing 700 grams of water, 250 grams of acrylic acid and 38 grams of calcium hydroxide are added; the temperature is then about 35° C. and it is left to react for 20 minutes.

Next, the partially neutralized acrylic acid is polymerized.

At the end of the reaction, 225 grams of sodium hydroxide are added at 45% concentration, and it is left to react for 25 minutes.

Finally, enough water is added so as to achieve an end concentration of polymer equal to 25% by dry weight.

### Test No. 6

This test illustrates the invention.

It is begun by polymerizing 250 grams of acrylic acid in 700 grams of water. In 80 grams of water being briskly agitated, 38 grams of calcium hydroxide are added, followed by 225 grams of sodium hydroxide at 45% concentration.

At 80° C., this mixture is added into the aqueous solution of polymerized acrylic acid, and it is left to react for 40 minutes.

Finally, enough water is added so as to achieve an end concentration of polymer equal to 25% by dry weight.

For each of the tests, table 2 shows the total time needed to neutralize the polymer, the FTU turbidity (measured for a concentration of polymer equal to 25% by dry weight), the molecular weight, and the polymolecularity index.

TABLE 2

| | Prior Art | Neutralization | | | |
|---|---|---|---|---|---|
| Test no. | Invention | time | FTU | Mw (g/mol) | Ip |
| 4 | PA | 2 hrs 40 min. | 25 | 10,000 | 2.8 |
| 5 | PA | 45 min. | 13 | 11,000 | 3.5 |
| 6 | Invention | 40 min. | 8 | 10,100 | 2.8 |

These results demonstrate that the inventive polymer is always the most limpid one. The efficiency of the method in comparison to the post-neutralization sequence method (test #5) has been improved: the neutralization time is much less.

In comparison to the pre-neutralization method (test #5), the resulting polymer has a much lower polymolecularity index, which is a sign of better practical properties.

### Example 3

This example illustrates the manufacturing of 2 homopolymers of acrylic acid, respectively:
having a molecular weight in the vicinity of 12,000 g/mol, of which 15% of the carboxylic sites by molar weight are neutralized by the calcium ion, 15% by the magnesium ion and 70% by the sodium ion: test #7,
having a molecular weight in the vicinity of 4,000 g/mol, of which 70% of the carboxylic sites by molar weight are neutralized by the calcium ion and 30% by the sodium ion: test #8

### Test No. 7

This test illustrates the invention.

It is begun by polymerizing 250 grams of acrylic acid in 700 grams of water. In 80 grams of water being briskly agitated, 19 grams of calcium hydroxide and 15 gams of magnesium hydroxide are added, followed by 225 grams of sodium hydroxide at 45% concentration.

At 80° C., this mixture is added into the aqueous solution of polymerized acrylic acid, and it is left to react for 30 minutes.

Finally, enough water is added so as to achieve an end concentration of polymer equal to 25% by dry weight.

### Test No. 8

This test illustrates the invention.

It is begun by polymerizing 250 gams of acrylic acid in 700 grams of water. In 80 grams of water being briskly agitated, 89 grams of calcium hydroxide are added, followed by 93 grams of sodium hydroxide at 45% concentration.

At 80° C., this mixture is added into the aqueous solution of polymerized acrylic acid, and it is left to react for 30 minutes.

Finally, enough water is added so as to achieve an end concentration of polymer equal to 25% by dry weight.

It is begun by polymerizing 250 grams of acrylic acid in an aqueous solution. Next, an aqueous solution containing 89 grams of calcium hydroxide and 93 grams of sodium hydroxide in a 45% concentration is produced at 80° C. by mixing the solutions of the corresponding hydroxides. At this same temperature, said mixture is added to the polymerized acrylic acid solution, and it is left to react for 30 minutes.

For each of the tests, table 3 gives the total time needed to neutralize the polymer, the FTU turbidity, the molecular weight, and the polymolecularity index.

TABLE 3

| | Prior Art | Neutralization | | | |
|---|---|---|---|---|---|
| Test no. | Invention | time | FTU | Mw (g/mol) | Ip |
| 7 | Invention | 30 | 9 | 12,000 | 2.9 |
| 8 | Invention | 30 | 5 | 4,000 | 2.3 |

These results demonstrate that very limpid polymers with a low polymolecularity index are successfully obtained. Furthermore, it is possible to obtain such characteristics for a divalent agent neutralization rate above 60% (70% calcium for test 8), which was strictly impossible with the method given in document WO 91/12278 (see the last paragraph of that document, before the experiment part).

The above written description of the invention provides a manner and process of making and using it such that any person skilled in this art is enabled to make and use the same, this enablement being provided in particular for the subject matter of the appended claims, which make up a part of the original description.

As used herein, the phrases “selected from the group consisting of,” “chosen from,” and the like include mixtures of the specified materials. Terms such as “contain(s)” and the like as used herein are open terms meaning ‘including at least’ unless otherwise specifically noted. The term “mentioned” notes exemplary embodiments, and is not limiting to certain species. As used herein the words “a” and “an” and the like carry the meaning of “one or more.”

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A method for manufacturing a water-soluble acrylic polymer, fully or partially neutralized by at least one monovalent agent and at least one divalent agent, comprising contacting said monovalent agent, said divalent agent, and a water-soluble acrylic polymer in acid form in an aqueous solution to produce a water-soluble acrylic polymer, fully or partially neutralized by at least one monovalent agent and at least one divalent agent.

2. The method of claim 1, comprising mixing an aqueous solution comprising said monovalent agent and said divalent agent with an aqueous solution comprising said acrylic polymer in acid form.

3. The method of claim 1, comprising:
manufacturing an aqueous solution of said monovalent agent and said divalent agent, and
mixing said solution of said monovalent agent and said divalent agent with an aqueous solution comprising the acrylic polymer in acid form.

4. The method of claim 1, wherein said water-soluble acrylic polymer, fully or partially neutralized by at least one monovalent agent and at least one divalent agent, exhibits:
an FTU (formazine turbidity unit) less than 10, for a concentration of 25% of polymer by dry weight,
and a polymolecularity index between 1.5 and 3.0 for a molecular weight between 5,000 g/mol and 15,000 g/mol.

5. The method of claim 1, wherein the monovalent agent is chosen from primary amines, lithium, potassium, and sodium hydroxides, and mixtures thereof.

6. The method of claim 1, wherein the divalent agent is chosen from secondary amines, calcium and magnesium hydroxide and/or oxides and mixtures thereof.

7. The method of claim 1, wherein said water-soluble acrylic polymer is fully neutralized.

8. The method of claim 1, wherein said water-soluble acrylic polymer is partially neutralized.

9. The method of claim 1, wherein said water-soluble acrylic polymer is obtained by radical polymerization in solution, in a direct or inverse emulsion, in a suspension or precipitation in solvent, in the presence of catalytic systems and transfer agents, or by processes of controlled radical polymerization.

10. The method of claim 1, wherein said water-soluble acrylic polymer is, before or after it is neutralized, treated and separated into several phases.

11. The method of claim 1, further comprising drying said fully or partially neutralized water-soluble acrylic polymer.

12. The method of claim 1, wherein said water-soluble acrylic polymer is a homopolymer of acrylic acid, or a copolymer of acrylic acid with another comonomer.

13. A water-soluble acrylic polymer, fully or partially neutralized by at least one monovalent agent and at least one divalent agent, which exhibits:
an FTU (formazine turbidity unit) less than 10, for a concentration of 25% of polymer by dry weight,
and a polymolecularity index between 1.5 and 3.0 for a molecular weight between 5,000 g/mol and 15,000 g/mol.

14. The polymer according to claim 13, wherein the monovalent agent is chosen from primary amines, lithium, potassium, and sodium hydroxides and mixtures thereof.

15. The polymer according to claim 13, wherein the divalent agent is chosen from among secondary amines, calcium and magnesium hydroxide and/or oxides and mixtures thereof, and preferentially from among calcium and magnesium hydroxide and/or oxides and mixtures thereof.

16. The polymer according to claim 13, wherein it is fully neutralized.

17. The polymer according to claim 13, wherein it is partially neutralized.

18. The polymer according to claim 13, wherein it is obtained by radical polymerization in solution, a direct or inverse emulsion, in a suspension or precipitation in solvents, in the presence of catalytic systems and transfer agents, or by processes of controlled radical polymerization and then fully or partially neutralized by at least one monovalent agent and at least one divalent agent.

19. The polymer according to claim 13, in the form of separated phases obtained using static or dynamic methods, by one or more polar solvents.

20. The polymer according to claim 13, wherein it is a homopolymer of acrylic acid, or a copolymer of acrylic acid with another comonomer.
